(19) United States
(12) Patent Application Publication
(10) Pub. No.: US 2026/0041079 A1
(43) Pub. Date: Feb. 12, 2026

(54) DEVICES AND METHODS FOR SELECTIVELY TRAPPING INSECTS

(71) Applicant: CORNELL UNIVERSITY, Ithaca, NY (US)

(72) Inventors: Sunghwan JUNG, Ithaca, NY (US); Anthony NICOLAIDES, Manalapan, NJ (US)

(21) Appl. No.: 19/270,110

(22) Filed: Jul. 15, 2025

Related U.S. Application Data
(60) Provisional application No. 63/671,605, filed on Jul. 15, 2024.

(51) Int. Cl. A01M 1/02; A01M 1/04; A01M 1/10

(52) U.S. Cl. CPC A01M 1/026; A01M 1/04; A01M 1/10

(57) ABSTRACT

An insect trap system includes an insect trap device and a computing device coupled to the insect trap device. The computing device includes a memory having instructions stored thereon for selectively trapping an insect in the insect trap device and one or more processors coupled to the memory and configured to execute stored instructions to determine an identity of an insect located within the insect trap device. The insect trap device is operated to selectively trap, based on the determined identity, the insect within the insect trap device. A method of selectively trapping an insect in an insect trap device is also disclosed.

This application claims the priority benefit of U.S. Provisional Patent Application Ser. No. 63/671,605, filed Jul. 15, 2024, which is hereby incorporated by reference in its entirety.

### GOVERNMENT FUNDING

This invention was made with government support under NA240ARX417C0598-T1-01 awarded by the National Oceanic and Atmospheric Administration. The government has certain rights in the invention.

### FIELD

The present technology relates to devices and methods for selectively trapping insects. More specifically, the present technology relates to devices and methods for accurately identifying insect species and selectively killing pest insects.

### BACKGROUND

Insect damage is a significant challenge to sustainable agriculture, as insects are highly mobile, making them a threat to crops, especially in the context of climate change-induced increases in insect populations. Insect damage results in substantial crop yield losses; approximately 20-40% of crop yields are lost due to insect damage. Insect traps often indiscriminately capture insects without distinguishing between those that harm or benefit crops, resulting in unintentional harm to beneficial insects.

Insect identification thus plays a critical role in sustainable agriculture and pest management, guiding the selection of appropriate control strategies. Insect identification helps to determine the pest type, avoiding unintentional harm to beneficial species. Proper identification also reduces human labor and decreases reliance on pesticides. Traditional insect identification methods rely on human expertise and are often time-consuming and prone to errors.

Automatic insect detection and identification systems utilizing AI are in the early stages of development, and several different approaches are being pursued. However, there are a number of challenges associated with AI-based insect identification and classification, such as the lack of reliable data sources, imbalanced datasets, and the difficulty of annotation. For instance, mobile devices that interface with cloud platforms to identify agricultural insect pests using deep learning and other neural network methods to improve pest detection models, and insect traps with deep learning models have been implemented. However, such systems have focused on insect identification and surveillance but not pest management.

For object detection models for insect identification and classification, cloud-based machine learning platforms like Microsoft Azure's Custom Vision.ai offer a cost-effective and accessible solution. However, they are extremely data-dependent, require manual annotation, and have data limitations, e.g., a maximum image number

The present technology is directed to overcoming these and other deficiencies in the art.

### SUMMARY

One aspect of the present technology relates to an insect trap system. The insect trap system includes an insect trap device and a computing device coupled to the insect trap device. The computing device includes a memory having instructions stored thereon for selectively trapping an insect in the insect trap device and one or more processors coupled to the memory and configured to execute stored instructions to determine an identity of an insect located within the insect trap device. The insect trap device is operated to selectively trap, based on the determined identity, the insect within the insect trap device.

Another aspect of the present technology relates to a method of selectively trapping an insect in an insect trap device implemented by an insect trap system. The method includes determining, an identity of an insect located within the insect trap device. The insect trap device is operated to selectively trap, based on the determined identity, the insect within the insect trap device.

This technology provides a number of advantages including provide systems and methods for pest management that allow for the identification of trapped species and the elimination of harmful pests, while protecting other species. The present technology provides a more accessible, reliable, and efficient method for species identification that can be used to identify a wider range of insect species. The devices and methods of the present technology advantageously employ advanced AI vision-based technology to accurately identify insect species and selectively kill pest insects. The present technology offers a sustainable and precise solution to reduce crop losses.

### BRIEF DESCRIPTION OF THE DRAWINGS

FIG. 1 is a schematic of an exemplary insect trap system including a side cross-sectional view of an insect trap device, according to an aspect of the present technology.

FIG. 2 is a top view of the exemplary insect trap device of the insect trap system shown in FIG. 1, according to an aspect of the present technology.

FIG. 3A is a top view of the entrance device of the insect trap device shown in FIG. 2, according to an aspect of the present technology.

FIG. 3B is a side exploded view of the exemplary insect trap device of the insect trap system shown in FIG. 1, according to an aspect of the present technology.

FIG. 4 is an illustration of the sequence of operation of the elimination chamber of the insect trap device shown in FIG. 2, according to an aspect of the present technology.

FIG. 5 is a block diagram of an exemplary computing device of the insect trap system shown in FIG. 1, according to an aspect of the present technology.

FIGS. 6A-6I show images that were used to obtain identification results

FIG. 7A-7D show images of an exemplary field trial setup. FIG. 7A is a top view of the field trial setup. FIG. 7B is a side view of the field trial setup. FIG. 7C is a distant view of the field trial setup. FIG. 7D is a schematic diagram of the field trial setup.

FIGS. 8A-8C are graphs of field test data for correct identification (FIG. 8A), wrong identification (FIG. 8B), and results not found (FIG. 8C).

FIG. 9 is a pie chart illustrating the categories of identification results for the field test data.

FIGS. 10A-10I are exemplary images of insects from the field test data with correct identification results.

FIGS. 11A-11F are exemplary images of insects from the field test data with misidentifications.

FIGS. 12A-12I are exemplary insect images from the field test data with relatively sufficient insect characteristics that are identified as not found.

FIGS. 13A-13C are exemplary insect images from the field test data.

FIG. 14 is a flow chart of an exemplary method of selectively trapping an insect in an insect trap device implemented by an insect trap system.

### DETAILED DESCRIPTION

The present technology relates to devices and methods for selectively trapping insects. More specifically, the present technology relates to devices and methods for accurately identifying insect species and selectively killing pest insects.

One aspect of the present technology relates to an insect trap system. The insect trap system includes an insect trap device and a computing device coupled to the insect trap device. The computing device includes a memory having instructions stored thereon for selectively trapping an insect in the insect trap device and one or more processors coupled to the memory and configured to execute stored instructions to determine an identity of an insect located within the insect trap device. The insect trap device is operated to selectively trap, based on the determined identity, the insect within the insect trap device.

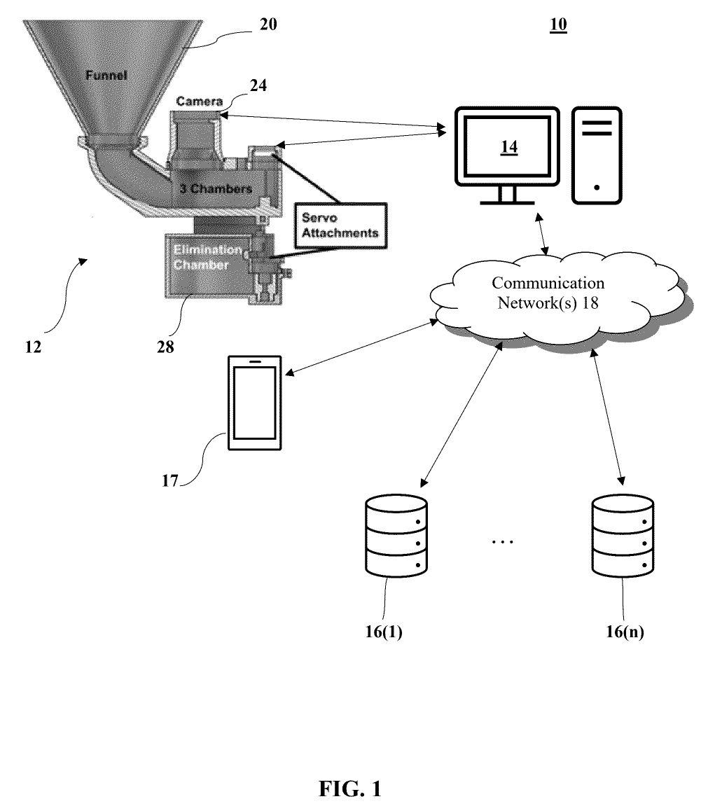

FIG. 1 is a schematic of an exemplary insect trap system 10 of the present technology. The insect trap system 10 in this example includes an insect trap device 12, a computing device 14, and one or more server devices 16(1)-16(n) coupled to the computing device 14 and an exemplary user device 17 through communication network(s) 18. The insect trap system 10 may include other types and/or numbers of devices or elements in other combinations. The present technology advantageously uses the power of machine learning to create an insect trap device that selectively targets and eliminates, for example, crop-damaging pests.

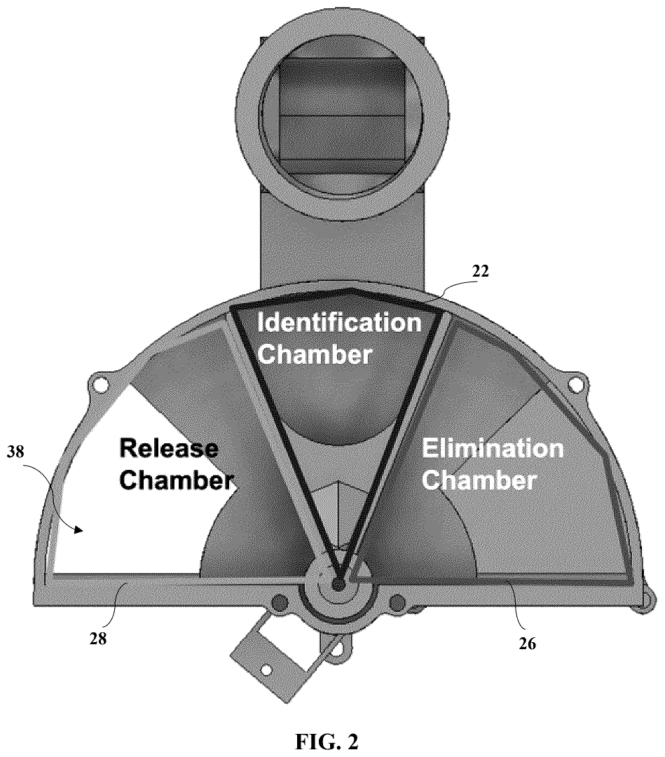

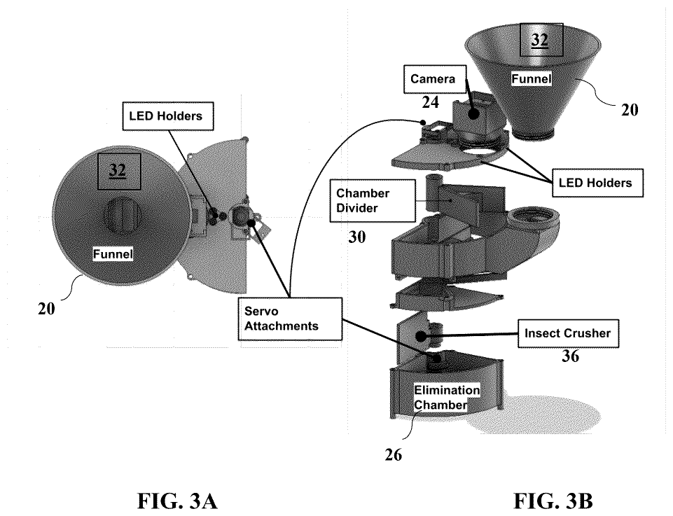

Referring now to FIGS. 2, 3A, and 3B, in this example, the insect trap device 12 includes an entrance device 20, an identification chamber 22, an imaging device 24, an elimination chamber 26, a release chamber 28, and a transfer device 30 although the insect trap device 12 may include other type and/or numbers of elements in other combinations.

The entrance device 20 is configured to direct an insect into the insect trap device 12 and into the identification chamber 22. In this example, the entrance device 20 is funnel shaped, although the entrance device 20 can have other configurations to introduce an insect into the insect trap device. The entrance device 20 can further include one or more attractor elements 32 located near the entrance thereof to draw insects into the entrance device 20, as shown for example in FIGS. 3A and 3B. By way of example, the attractor elements can include one or more lights, one or more LED lights, scents, chemical attractants, pheromones, or combinations thereof. For example, ultraviolet lights may be employed that are equipped with small diodes and diffusers. These diodes are energy-efficient, allowing the device to extend the time of use. The entrance device 20 is coupled to the identification chamber 22 such that insects entering the entrance device 20 are introduced into the identification chamber 22.

The identification chamber 22 is coupled to the entrance device 20. In some examples, the identification chamber 22 includes a closure mechanism that prevents an insect that enters the identification chamber 22 through the entrance device 20 from leaving the insect trap device 12 through entrance device 20. The identification chamber 22 may include one or more LEDs or other light providing devices to illuminate the identification chamber 22 for capturing images of insects located therein.

The insect trap device 12 further includes an imaging device 24 that is positioned to obtain an image of an insect located in the identification chamber 22 through an aperture in the identification chamber 22. The imaging device 24 can be, for example, a camera or an infrared camera, although other imaging devices capable of obtaining images of insects located in the identification chamber 22 can be employed. The imaging device 24 is coupled to the computing device 14 to provide the obtained images to the computing device 14. The imaging device 24 can be coupled to the computing device 14 through wired or wireless connections, such as through a communication network.

Referring now more specifically to FIG. 2, the insect trap device 12 also includes the elimination chamber 26 and the release chamber 28 coupled to the identification chamber 22. As shown in FIG. 3B, the insect trap device 12 also includes a transfer device 30 that divides the identification chamber 22, elimination chamber 26, and the release chamber 28. The transfer device 30 is configured to selectively transfer an insect located in the identification chamber 22 to either the elimination chamber 26 or the release chamber 28. By way of example, the transfer device 30 can be a moveable divider operated by one or more servo motors controlled by the computing device 14, although the transfer device 30 can be operated in other manners. In this example, the transfer device 30 is shaped similar to the identification chamber 22, elimination chamber 26, and the release chamber 28, such that the transfer device 30 defines the outer walls of each chamber when transferred thereto.

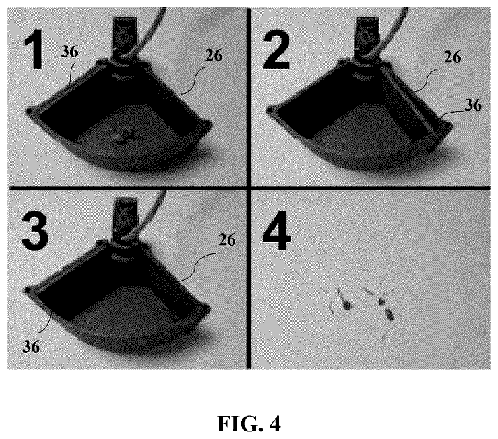

Referring again to FIG. 2, the elimination chamber 26 is configured to kill the insect when it is determined that the insect is a harmful pest, as described in the examples below. In this example, referring to FIGS. 3B and 4, the elimination chamber 26 includes an insect crusher device 36 configured to move within the elimination chamber 26 to crush the insect when located in the elimination chamber 26. By way of example, the insect crusher device 36 can be a moveable panel operated by one or more servo motors controlled by the computing device 14, although other types of insect crusher devices 36 could be employed. FIG. 4 illustrates a sequence of images showing the operation of the insect crusher device 36. Image 1 in FIG. 4 shows an insect located in the elimination chamber 26 with the insect crusher device 36 located to one side of the elimination chamber 26. Image 2 illustrates the movement of the insect crusher device 36 to the opposite side of the elimination chamber 26 to crush the insect against the sidewall of the elimination chamber 26. Image 3 shows the insect crusher device 36 returned to the starting position shown in Image 1. Image 4 illustrates an exemplary crushed insect as a result of the operation of the insect crusher device 36.

Referring again to FIG. 2, the release chamber 28 is configured to release the insect from the insect trap device 12. In this example, the release chamber 28 includes an opening 38 that allows the insect to exit the insect trap device 12 when the insect is determined to be non-harmful in accordance with the methods disclosed herein below.

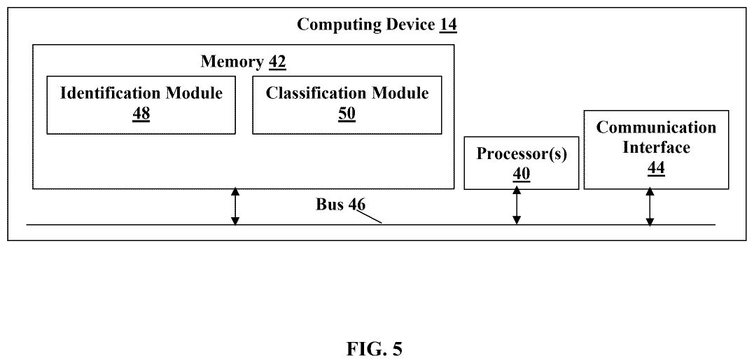

Referring now to FIGS. 1 and 5, the insect trap system 12 includes the computing device 14 coupled to the insect trap device 12 to control one or more operations of the insect trap device 12 as described herein. Although computing device 14 is illustrated and described, it is to be understood that one or more of the functions described could be performed, for example, on one or more of the servers 16(1)-16(n). The computing device 14 in this example includes one or more processor(s) 40, a memory 42, and a communication interface 44, which are coupled together by a bus 46, although the computing device 14 can include other types or numbers of elements in other configurations.

The processor(s) 40 of the computing device 14 may execute programmed instructions stored in the memory 42 of the computing device 14 for any number of the functions identified above. The processor(s) 40 of the computing device 14 may include one or more central processing units (CPUs) or general purpose processors with one or more processing cores, for example, although other types of processor(s) can also be used.

The memory 42 of the computing device 14 stores these programmed instructions for one or more aspects of the present technology as described and illustrated herein, although some or all of the programmed instructions could be stored elsewhere, such as on servers 16(1)-16(n), by way of example. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 40, can be used for the memory 42.

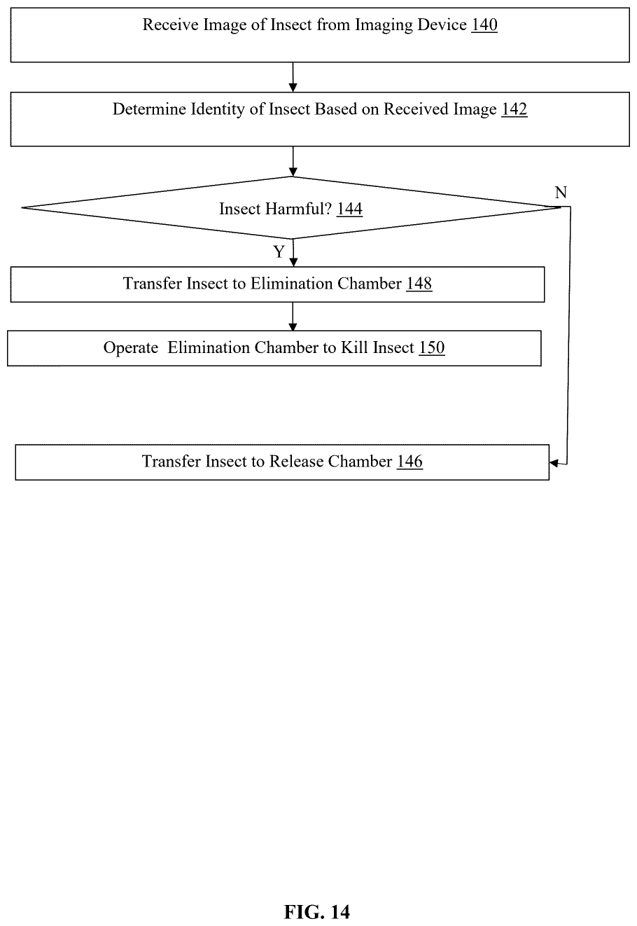

Accordingly, the memory 42 of the computing device 14 can store one or more modules that can include computer executable instructions that, when executed by the computing device 14, cause the computing device 14 to perform actions described and illustrated below with reference to FIG. 14, by way of example only. The modules can be implemented as components of other modules. Further, the modules can be implemented as applications, operating system extensions, plugins, or the like.

Even further, the modules may be operative in a cloud-based computing environment. The modules can be executed within or as virtual machine(s) or virtual server(s) that may be managed in a cloud-based computing environment. Also, the modules, and even the computing device 14 itself, may be located in virtual server(s) running in a cloud-based computing environment rather than being tied to one or more specific physical network computing devices. Also, the modules may be running in one or more virtual machines (VMs) executing on the computing device 14. Additionally, in one or more examples of this technology, virtual machine(s) running on the computing device 14 may be managed or supervised by a hypervisor.

In this particular example, the memory 42 of the computing device 14 includes an identification module 48 and a classification module 50, although identification module 48 and classification module 50 can be located, for example, on the servers 16(1)-16(n).

In this example, the identification module 48 can provide a trained artificial intelligence model that is used to analyze received images obtained by the imaging device 24 to determine the identity of the insect located in the received image. The identification module 48 can include a machine learning model generated via supervised or unsupervised training and may utilize deep learning models, such as a convolutional neural network (CNN) or long short-term memory (LSTM), for example. In other examples, the identification module 48 can incorporate a binary classifier, such as a support vector machine (SVM), logistic regression, random Forest, or XGBoost, for example, although other types of machine learning models can also be used in other examples. The trained artificial intelligence model may employ a database of relevant insect images. One example of a database of images is the iNaturalist database, which is a nonprofit crowdsourced species identification database, as disclosed in Carrie, S. About. iNaturalist. https://www.inaturalist.org/pages/about (2024). iNaturalist has acquired a sizable collection of “research grade” image observations and has made CV classification models to identify uploaded observations as disclosed in Ackland, S., et al., “A method for conveying confidence in iNaturalist observations: A case study using non-native marine species. Ecology and Evolution,” 14, e70376. https://doi.org/10.1002/ece3.70376 (2024), the disclosure of which is incorporated herein by reference in its entirety. In some examples, the identification module 48 can further use geolocation data to assist in rendering the determination of the identity of the insect.

In this example, the classification module 50 can determine whether an identified insect is harmful based on the determined identity of the insect. The classification module 50 can include a machine learning model generated via supervised or unsupervised training and may utilize deep learning models, such as a convolutional neural network (CNN) or long short-term memory (LSTM), for example. In other examples, the classification module 50 can incorporate a binary classifier, such as a support vector machine (SVM), logistic regression, random Forest, or XGBoost, for example, although other types of machine learning models can also be used in other examples. In one example, a model such as Chat GPT can be used to determine whether the identified insect is harmful based on a simple query using the identity of the insect.

Referring back to FIGS. 1 and 5, the communication interface 44 of the computing device 14 operatively couples and communicates between the computing device 14 and server devices 16(1)-16(n), as well as user device 17, which are coupled together at least in part by the communication network(s) 18, although other types or numbers of communication networks or systems with other types or numbers of connections or configurations to other devices or elements can also be used.

By way of example only, the communication network(s) 18 can include local area network(s) (LAN(s)) or wide area network(s) (WAN(s)) and can use TCP/IP over Ethernet and industry-standard protocols, although other types or numbers of protocols or communication networks can be used. The communication network(s) 18 in this example can employ any suitable interface mechanisms and network communication technologies including, for example, teletraffic in any suitable form (e.g., Ethernet-based Packet Data Networks (PDNs)).

While the computing device 14 is illustrated in this example as including a single device, the computing device 14 in other examples can include a plurality of devices or blades each having one or more processors (each processor with one or more processing cores) that implement one or more steps of this technology. In these examples, one or more of the devices can have a dedicated communication interface or memory. Alternatively, one or more of the devices can utilize the memory 42, communication interface 44, or other hardware or software components of one or more other devices included in the computing device 14.

Additionally, one or more of the devices that together comprise the computing device 14 in other examples can be standalone devices or integrated with one or more other devices or apparatuses, such as the one or more of the servers 16(1)-16(n), for example. Moreover, one or more of the devices of the computing device 14 in these examples can be in a same or a different communication network including one or more public, private, or cloud networks, for example.

Each of the server devices 16(1)-16(n) of the insect trap system 10 in this example includes processor(s), a memory, and a communication interface, which are coupled together by a bus or other communication link, although other numbers or types of components could be used. The servers 16(1)-16(n) in this example can include application servers, database servers, or access control servers, for example, although other types of server devices can also be included in the insect trap system 10.

Accordingly, in some examples, one or more of the servers 16(1)-16(n) process login and other requests received from the computing device 14 via the communication network(s) 18 according to the HTTP-based application RFC protocol, for example. A web application may be operating on one or more of the servers 16(1)-16(n) devices and transmitting data (e.g., files or web pages) to the computing device 14 in response to requests therefrom. The servers 16(1)-16(n) may be hardware or software or may represent a system with multiple servers in a pool, which may include internal or external networks.

Although the servers 16(1)-16(n) are illustrated as single devices, one or more actions of each of the servers 16(1)-16(n) may be distributed across one or more distinct network computing devices that together comprise one or more of the servers 16(1)-16(n). Moreover, the servers 16(1)-16(n) are not limited to a particular configuration. Thus, the servers 16(1)-16(n) may contain network computing devices that operate using a master/slave approach, whereby one of the network computing devices of the servers 16(1)-16(n) operate to manage or otherwise coordinate operations of the other network computing devices. The servers 16(1)-16(n) may operate as a plurality of network computing devices within a cluster architecture, a peer-to peer architecture, virtual machines, or within a cloud architecture, for example.

User device 17 of the insect trap system 10 in this example includes processor(s), a memory, and a communication interface, which are coupled together by a bus or other communication link, although other numbers or types of components could be used. User device 17 can be used to interface with the computing device 14 to obtain information, such as logs regarding the identified insects, or to provide instructions to the computing device 14 to control one or more operations of the insect trap device 12.

Another aspect of the present technology relates to a method of selectively trapping an insect in an insect trap device implemented by an insect trap system. The method includes determining, an identity of an insect located within the insect trap device. The insect trap device is operated to selectively trap, based on the determined identity, the insect within the insect trap device.

FIG. 14 is a flow chart of an exemplary method of selectively trapping an insect in the insect trap device 12, described above, as implemented by the insect trap system 10.

First, in step 140 the computing device 14 receives the image of the insect from the imaging device 24. In step 142, the computing device 14 determines the identity of the insect based on the received image. The received image of the insect can be analyzed using a trained artificial intelligence model, such as described with respect to identification module 48 above. The trained artificial intelligence algorithm can employe a database of relevant insect images, such as the iNaturalist database as described above.

Next, in step 144, the computing device 14 determines whether the insect is harmful based on the determined identity of the insect. The computing device 14 can determine whether the insect is harmful based on a trained artificial intelligence model, such as described with respect to classification module 50 above.

If in step 144, the computing device 14 determines that the insect is not harmful, the N branch is taken to step 146. In step 146, the computing device 14 operates the transfer device 30, for example using servo motors coupled to the transfer device 30, to transfer the insect to the release chamber 28 to release the insect from the insect trap device 12. Examples of non-harmful insects include a housefly, a common house spider, a bumble bee, an Asian lady beetle, a butterfly, and a grasshopper.

If in step 144, the computing device 14 determines that the insect is a harmful pest, the Y branch is taken to step 148. In step 148, the computing device 14 operates the transfer device 30, for example using servo motors coupled to the transfer device 30, to transfer the insect to the elimination chamber 26. In some examples, in step 150, the computing device 14 operates the insect crusher 36, for example using servo motors coupled to the insect crusher 36, to kill the insect located in the elimination chamber 26. Examples of harmful insects can include a stink bug, a Japanese beetle, a corn earwork, a spotted lanternfly, a three-lined potato beetle, a potato beetle, a German cockroach, or a gypsy moth.

### EXAMPLES

### Example 1—Insect Trap Device Prototype

Software was developed to employ commercial platforms for the insect trap system of the present technology, enhancing the capabilities of the AI algorithm. A prototype was developed using this software integrated into an onboard microprocessor. A 3D printer was utilized for crafting the body, and two micro servos were employed for actuation of the chamber divider and insect crusher. The chamber divider creates three chambers: identification, elimination, and release chambers. The insect moves into the identification chamber via the funnel. Then the software will decide (via the overhead camera) if the insect should be moved to the elimination or release chamber. The release chamber simply releases the insect, while the elimination chamber crushes it with the insect crusher.

A proof-of-concept was developed to evaluate performance of the insect trap device. The approach to creating a smart insect trap involved using 3D-printed components and readily available tubing. For the placement of a camera and microprocessor, one of the chamber's side walls was modified. Within the identification chamber, an image of the insect was captured and analyzed. Depending on the identification result, the micro servos are employed to move the chamber divider to direct the insect either into a channel for pest elimination or into a channel for release.

To attract insects, UV lights were employed equipped with small diodes and diffusers. These diodes are energy-efficient, allowing the device to extend the time of use. In order to guide insects toward the central identification chamber, a gradient of light intensity was established. Additionally, the use of pheromones was explored to further enhance insect attraction.

In order to minimize maintenance requirements, a non-adhesive surface was used to prevent insects or their debris from sticking. Some commercial coatings include (PTFE-30LX) that effectively reduces adhesion by insects.

The device was designed to be portable and adaptable for use at different heights depending on the crop height, with the potential integration with solar panel power. Users will be able to easily install it in various locations within the field. Additionally, the device may be enabled to have connectivity with users' smartphone apps for real-time field insect monitoring and the delivery of weekly or monthly reports on identified insects.

### Example 2—Raspberry PI Initiation

A Raspberry Pi OS (Debian, version 12) was utilized, with a main Python script for initializing the various components of the insect trap device as described above. The main script had a reboot monitor, also called a “heartbeat monitor,” that will restart the Raspberry Pi if the system stalls, limiting necessary hands-on maintenance. The primary components controlled include the Raspberry Pi Camera Module 3, v1.3, LED lights, servo motors, and a webdriver.

The main script interfaced with the camera via the package PiCamera2 to produce a 640×480 RGB JPG image. A smaller image size was used compared to the maximum size available on the camera to enable faster processing, yet still provide enough detail for classification. Raspberry Pi Infrared cameras are also available in the same form factor and could be interchanged to enable dim lighting classification as some insects are primarily nocturnal.

The LEDs, both in the funnel and chamber, were controlled in coordination with the camera or could be set to remain on in low light settings. The visible light LEDs could be supplemented or replaced with infrared LEDs to facilitate capturing images at night. Ultraviolet LEDs on top were added for field tests, as some insects are attracted to UV light well.

The servo motors were initialized with the Python library “pigpio,” which allows for control of the General Purpose Input Outputs (GPIO) on the Raspberry Pi. The last component initialized was a Python webdriver, specifically the package Selenium. This webdriver accesses the iNaturalist website, logs in with a previously established user account, and loads the observation upload webpage.

### Example 3—Image Identification and Pest Detection

With the Raspberry Pi components initialized, the camera was set to capture images at five second intervals. Once an image was captured and saved to the SD card, the webdriver uploaded the image to the iNaturalist observation page and waited for taxa classification by the iNaturalist CV model v2.17. The model returns the most specific taxa level classification with a confident inference. Ideally, this will be at the species or genus level, however a family level identification is often sufficient in insect pest management. The device obtained the scientific name, common name if present, and an iNaturalist taxa identification number. If the model did not have sufficient confidence, no identification was made, however possible suggestions were offered. The device only considered the primary identification and logged the suggestions. The metadata on the captured image could be modified to include geolocation information which allows slight accuracy improvement in the model predictions.

### Example 4—Image Classification

Although several online pest tracker lists and reference databases exist for pest classification, they are often incomplete, inconsistent, or not directly aligned with iNaturalist's taxonomic nomenclature. Moreover, the classification of an organism as a “pest” depends on a variety of factors, including geographic region, target cop, regulatory status and so on. Given these complexities, a fixed pest dictionary is relatively inflexible and insufficient for broader application scenarios. To address this, OpenAI was integrated to provide a more adaptable and context-aware classification approach.

With the insect identification result from the iNaturalist website, the device extracted the taxon most likely scientific name. A prompt in format “Is [Insect Scientific Name] a pest or not?” was sent to ChatGPT. The model was instructed to return “YES,” “NO,” or “UNCERTAIN,” corresponding respectively to: the organism being a known pest, not a pest, or having pest status that varies by subspecies or region. Based on the returned classification, the insect was classified as a pest if the response was “YES,” or a non-pest if the response was “NO” or “UNCERTAIN.” This result then informed the subsequent actions including saving the image with classification information to a corresponding folder, and executing servo commands to either kill or release the insect.

The AI-driven method enabled dynamic prompt adjustment, allowing the classification system to be easily tailored for specific crops, regions, or evolving pest management criteria. It provided practical flexibility, allowing users to refine identifications standard as project needs change.

Finally, after the insect was identified and classified, the main script activated the servos motors to either release or capture/kill the insect. Each observation was recorded to a log and saved to the SD card. The log entry included the image file, scientific name, common name (if available), first top suggestion scientific name (if available), date and time, and action taken by device i.e., release or capture. Additionally, the logs could be uploaded regularly to be accessed by the user online at regular intervals and to delete old observations from the SD card memory. If primary motivation is to survey or tally insects, the capture function could be disabled so that all insects are released.

### Example 5—Insect Trap Device Design

A Raspberry Pi 4 Model B was picked for its small footprint, which allows for a more compact design of the physical insect catcher. The camera used for insect identification was the Raspberry Pi Camera v1.3. Furthermore, the SG90 servo motors were used for the small, lightweight design.

The physical device was 3D printed and consisted of a funnel, chamber housing, and a killing chamber. The insect entered through the funnel and into the chamber housing, specifically the identification chamber. The camera then viewed the insect in the chamber and the iNaturalist identification model and pest dictionary determined if the insect was harmful or not. Harmful insects were moved into the killing chamber, while the safe insects were released. This was controlled via a servo motor that moves the insect from chamber to chamber.

Once in the killing chamber a servo motor was used to crush the insect. As of now hard shelled insects, like certain beetles, have the potential to survive. However, a stronger motor would resolve this issue, at the expense of compactness.

The funnel was modified to attract insects. An array of UV lights were attached on the inside to help attract insects, pheromone-based methods could also be used to attract insects. These pheromones would be inserted into the funnel and allow for attracting insects day and night, whereas UV is only most effective as night.

### Example 6—Insect Identification and Subsequent Processes

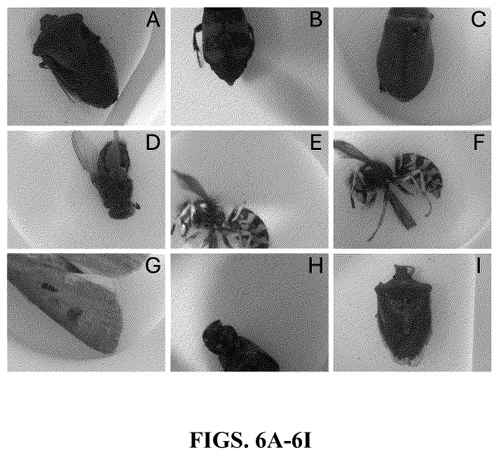

The program was successful at correctly identifying insects from museum samples that entered the device. FIGS. 6A-6I show images that were used to obtain identification results using the iNaturalist database. All except one image was classified correctly at the family taxon level or lower. The identification results are shown in Table 1 below:

TABLE 1
Insect Image Identification Results for Museum Samples

| Image | Identification |
|---|---|
| 6A | Family Pentatomidae |
| 6B | Genus Nicrophorus |
| 6C | Family Scarabaeidae |
| 6D | Genus Calliphora |
| 6E | Subfamily Vespinae |
| 6F | Genus Dolichovespula |
| 6G | Genus Agrotis |
| 6H | Not Found |
| 6I | Genus Euschistus |

FIG. 6F demonstrates that with a better image compared to FIG. 6E, a lower level taxon identification was given. The insect in FIG. 6H was the same as in FIG. 6B, but was positioned on its back, which was likely an image with few training examples. Most insects were identified at the family and genus level, which is typically sufficient for managing pests. Several of the images only captured partial segments of the insects body, e.g., just the wing or abdomen. This helped to mimic the testing with live insects that will most likely not stay in full frame for the duration they are in the chamber. Fortunately, iNaturalist was still able to correctly identify at the genus taxon level (FIG. 6B, 6G). Three overhead white LED lights were used to illuminate the chamber to minimize shadows by providing light from multiple directions to allow a clear image to be passed to iNaturalist.

### Example 7—Field Testing

A field test was conducted over 4 days, 2 nights at latitude 42.435°N, longitude 76.495° W. The field test used a charged battery with no solar panel, however it did show that the physical design was fit for its purpose, being able to last under outdoor conditions for long periods of time. The addition of a solar panel could allow the device and program to run for significantly longer without intervention.

Images of the field trial setup are shown in FIGS. 7A-7D. To increase the efficiency of attracting and capturing insects, a commercially available UV insect trap with an inside fan was used. The UV insect trap's collection chamber was opened, and the trap was mounted onto a cardboard box, while the device's funnel equipped with LEDs was positioned beneath. This setup allows insects attracted by the light to be sucked in by the fan, drawn through the funnel, and subsequently directed into the insect identification chamber.

Based on the images saved on the Raspberry Pi, images that were blurry or only showed partial insect bodies lacking sufficient diagnostic features for species identification were first filtered out. The remaining images were organized by the corresponding species' scientific names and categories into three groups: correctly identified, misidentified, and insect present but classified as “Not Found” by the system. For each identified species, the number of images in each category is presented in Tables 2A and 2B, while the corresponding percentages relative to the total number of images per species are shown in Tables 3A and 3B.

TABLE 2A
Image Identification Results for each Species of Insect Trapped by the Device

| Species Scientific | | | Not |
|---|---|---|---|
| Name | Identified Correct | Identified Wrong | Found |
| Genus Stephanitis | 2 | 2 (Genus Anthrenus) | 27 |
| | | 1 (Superfamily Miroidea) | |
| Tribe Sericini | 1 | | |
| Tribe Aphidini | 3 (Tribe Aphidini) | 3 (Family Formicidae) | 10 |
| | 6 (Subfamily Aphididae) | | |
| | 1 (Family Aphididae) | | |
| Family Mymaridae | | | 2 |
| Lachesilla Pedicularia | | | 3 |
| Genus Nipponoserica | 1 (Family Scarabaeidae) | | 1 |
| | 1 (Tribe Sericini) | | |
| | 1 (Genus Nipponoserica) | | |
| Genus Trentepohlia | 1 (Genus Trentepohlia) | 1 (Genus Antocha) | 1 |
| | 1 (Family limoniidae) | | |
| | 1 (Superfamily Tipuloidea) | | |
| Superfamily Tipuloide | 6 | | 5 |
| Genus Monarthropalpus | 14 (Genus Monarthropalpus) | | 2 |
| | 1 (Tribe Eriopterini) | | |
| Tribe Lathrobiiini | 4 | | 2 |
| Tribe Macrosiphini | 2 (Tribe Macrosiphini) | | |
| | 3 (Subfamily Aphidinae) | | |
| Genus lachesilla | | | 1 |

TABLE 2B
Image Identification Results for each Species of Insect Trapped by the Device (cont.)

| Species Scientific | | | Not |
|---|---|---|---|
| Name | Identified Correct | Identified Wrong | Found |
| Genus Mycomya | 1 | | |
| Superfamily Culicinae | 3 | | |
| Genus Aedes | 19 (Genus Aedes) | | 1 |
| | 3 (Tribe Aedes) | | |
| | 21 (Subfamily Culicinae) | | |
| Genus Rhyssemus | 1 | | |
| Genus Staphylinidae | 1 | | |
| Subfamily | 3 | | |
| Chironominae | | | |
| Genus Rhagio | 39 | | |
| Genus Culex | 3 (Genus Culex) | | 1 |
| | 1 (Subfamily Culicinae) | | |
| Genus Depressaria | 4 | | |
| Superfamily Sciaroidea | 1 | | |
| Genus Molophilus | 2 | | |
| Subtribe Chironomus | 1 | | |
| Family Limoniidae | 3 | | 1 |
| Genus Mystacides | 2 | 1 (Genus Psilochorema) | 1 |
| | | 3(Superfamily Blaberoidea) | |
| | | 2 Superfamily Gelechioidea) | |
| Genus Anopheles | 2 | | 1 |
| Subgenus Cricotopus | | 1 (Family Veliidea) | |
| Genus Paraproba | | | 1 |
| Clivina Fossor | | | 2 |
| Thaumatomyia notata | | | 2 |
| Psychoda alternata | | | 1 |
| Thaumatomyia notata | | | 1 |

TABLE 3A
Image Identification Percentages for each
Species of Insect Trapped by the Device

| Species Scientific | Average Size | Identified | Identified | Not |
|---|---|---|---|---|
| Name | (mm) | Correct | Wrong | Found |
| Family Mymaridae | 0.65 | 0 | 0 | 1 |
| Lachesilla | 1.75 | 0 | 0 | 1 |
| Pedicularia | | | | |
| Genus lachesilla | 1.75 | 0 | 0 | 1 |
| Tribe Aphidini | 2 | 0.409 | 0.136 | 0.455 |
| Genus | 2.5 | 0.882 | 0 | 0.118 |
| Monarthropalpus | | | | |
| Thaumatomyia | 3 | 0 | 0 | 1 |
| notata | | | | |
| Psychoda alternata | 3 | 0 | 0 | 1 |
| Thaumatomyia | 3 | 0 | 0 | 1 |
| notata | | | | |
| Genus Stephanitis | 3.5 | 0.062 | 0.094 | 0.844 |
| Tribe Macrosiphini | 3.5 | 1 | 0 | 0 |
| Subgenus | 4.5 | 0 | 1 | 0 |
| Cricotopus | | | | |
| Genus Paraproba | 4.5 | 0 | 0 | 1 |
| Genus Culex | 5.5 | 0.800 | 0 | 0.200 |
| Superfamily | 5.5 | 1 | 0 | 0 |
| Culicinae | | | | |
| Genus Aedes | 5.5 | 0.977 | 0 | 0.023 |
| Genus Rhyssemus | 5.5 | 1 | 0 | 0 |

TABLE 3B
Image Identification Percentages for each Species
of Insect Trapped by the Device (cont.)

| Species Scientific | Average Size | Identified | Identified | Not |
|---|---|---|---|---|
| Name | (mm) | Correct | Wrong | Found |
| Superfamily | 5.5 | 1 | 0 | 0 |
| Sciaroidea | | | | |
| Genus Molophilus | 5.5 | 1 | 0 | 0 |
| Genus | 6 | 1 | 0 | 0 |
| Staphylinidae | | | | |
| Subfamily | 6 | 1 | 0 | 0 |
| Chironominae | | | | |
| Genus Anopheles | 6 | 0.666 | 0 | 0.333 |
| Clivina Fossor | 7 | 0 | 0 | 1 |
| Genus Mycomya | 7 | 1 | 0 | 0 |
| Superfamily | 7.5 | 1 | 0 | 0 |
| Muscoidea | | | | |
| Subtribe | 8 | 1 | 0 | 0 |
| Chironomus | | | | |
| Genus | 8.5 | 0.750 | 0 | 0.250 |
| Nipponoserica | | | | |
| Genus Rhagio | 9 | 1 | 0 | 0 |
| Tribe Sericini | 9 | 1 | 0 | 0 |
| Tribe Lathrobiiini | 9 | 0.667 | 0 | 0.333 |
| Genus Depressaria | 9.5 | 1 | 0 | 0 |
| Family Limoniidae | 10 | 0.750 | 0 | 0.250 |

TABLE 3C
Image Identification Percentages for each Species
of Insect Trapped by the Device (cont.)

| Species Scientific | Average Size | Identified | Identified | Not |
|---|---|---|---|---|
| Name | (mm) | Correct | Wrong | Found |
| Genus Mystacides | 13.5 | 0.222 | 0.667 | 0.111 |
| Genus Trentepohlia | 15 | 0.600 | 0.200 | 0.200 |
| Superfamily | 15 | 0.545 | 0 | 0.455 |
| Tipuloide | | | | |

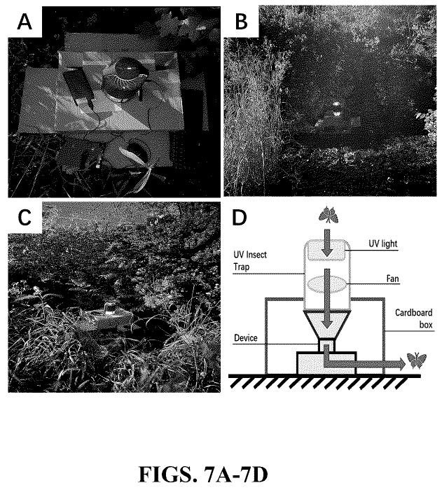

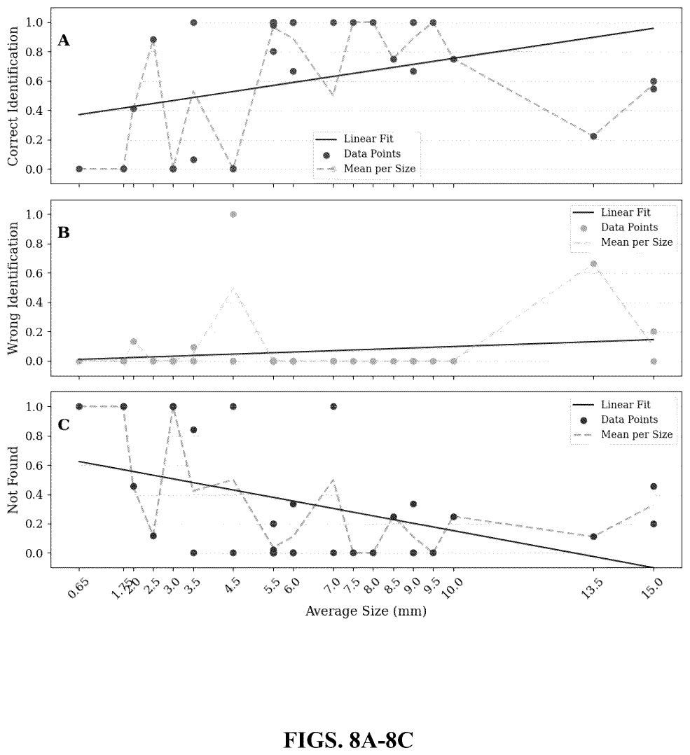

The identification results suggest a correlation between identification accuracy and the insect average size of the insect. For each insect, the percentages of correct identification, misidentification, and not-found cases are calculated by dividing the number of images in each category by the total number of images. Since multiple species may share a similar average size, a single average size can correspond to several percentage values per category. FIGS. 8A-8C show graphs of average size versus identification results for correct identifications (FIG. 8A), wrong identifications (FIG. 8B), and results not found (FIG. 8C). To visualize this, the mean of these percentage values were used as the representative point for each size, forming the basis for connecting data points across different sizes. The mean per size data points were used to draw dashed lines, while all the points are used to compute linear regression lines.

Based on the linear regression lines, as the average size of the insect samples increases, the percentage of correct identification tends to rise, while the percentage of not-found decreases. The percentage of misidentification oscillates randomly, which may be attributed to certain species being more easily confused with visually similar insects, and the specific characteristics shown in the image being taken.

The insect images are categorized into four categories based on the identification result and actual result, and the total number of each category is counted. In total, the 719 images were evaluated to assess the accuracy of the insect identification system of the device. The images were classified into four categories as indicated in Table 4 below:

TABLE 4
Insect Image Identification Result Categorization

| Category | Identification Result | Number of Images |
|---|---|---|
| 1a | True Positive - image identified as correct species | 170 |
| 1b | True Positive - no insect present or insufficient | 460 |
| | characteristics, identified as Not-Found | |
| 2 | False Positive - image has no insect present or | 8 |
| | insufficient characteristics, identified as Found and | |
| | certain species | |
| 3 | True Negative - image identified as wrong insect species | 14 |
| 4 | False Negative - the image has insects present, identified | 67 |
| | as Not Found and no species | |

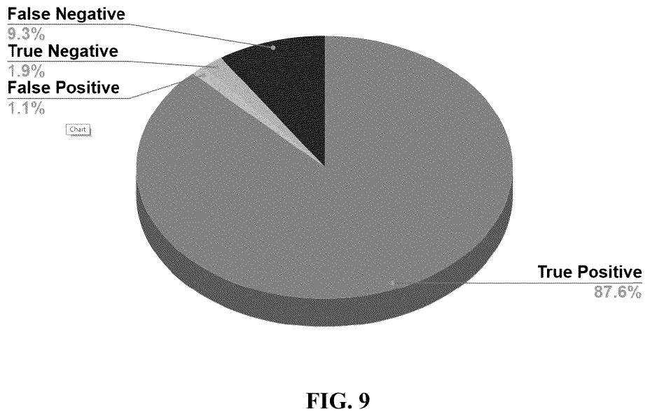

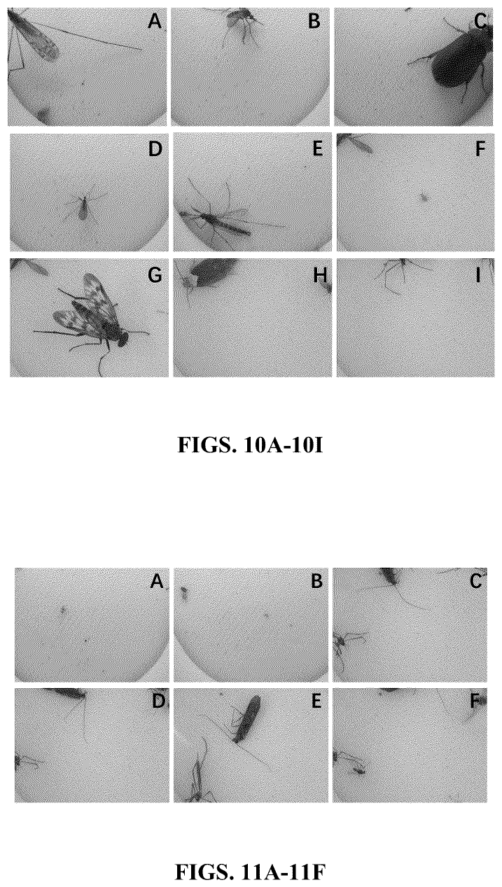

As show in FIG. 9, the combined value of the True Positives for Correct identification and Correctly Not Found cases account for 87.6% of the total, indicating a relatively high identification accuracy. FIGS. 10A-10I are exemplary insect images from the field trial results with correct identification results as summarized in Table 5 below:

TABLE 5
Insect Image Identification with Correct Identification

| Image | Identification |
|---|---|
| 10A | Family Limoniidae |
| 10B | Genus Culex |
| 10C | Tribe Sericini |
| 10D | Genus Monarthropalpus |
| 10E | Genus Aedes |
| 10F | Subfamily Aphidinae |
| 10G | Genus Rhagio |
| 10H | Genus Depressaria |
| 10I | Subfamily Culicine |

FIGS. 11A-11F are exemplary insect images from the field trial results with misidentification results, i.e., true negatives, as summarized in Table 6 below.

TABLE 6
Insect Image Identification with Incorrect Identification

| Image | Identification | Actual |
|---|---|---|
| 11A | Genus Anthrenus | Genus Stephanitis |
| 11B | Family Formicidae | Tribe Aphidini |
| 11C | Superfamily Blaberoidea | Genus Mystacides |
| 11D | Superfamily Gelechioidea | Genus Mystacides |
| 11E | Genus Psilochorema | Genus Mystacides |
| 11F | Family Veliidae | Subgenus Cricotopus |

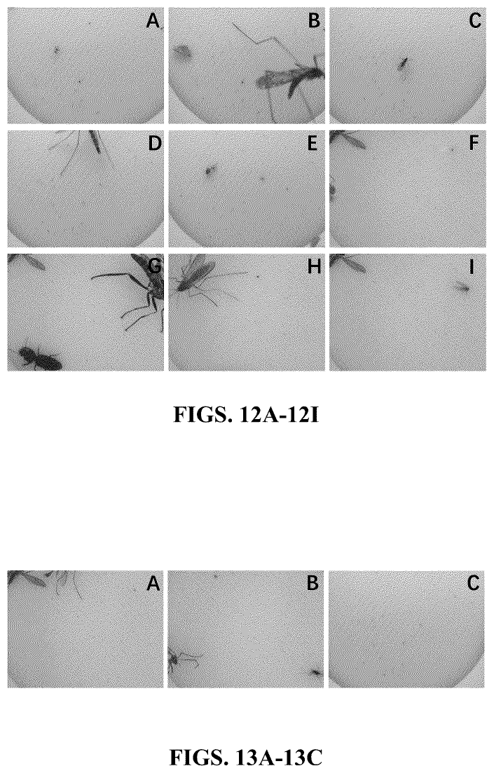

FIGS. 12A-12I are exemplary insect images from the field trial results that resulted in false negative results. The images contain relatively sufficient insect characteristics but are identified as not found. FIGS. 13A-13C are exemplary insect images from the field trial results that resulted in false positive results. The images contain insufficient characteristics for identification but were categorized as found with the following insect species identified: FIG. 13A—Subfamily Culicinae; FIG. 13B—Superfamily Araneoidea; FIG. 13C-Family Formicidae.

The insect images with correct identification results (True Positive) typically display the insect's full body from a clear angle with distinct morphological features. In cases where only partial features are visible, correct identification is still often achieved if the most characteristic traits of the species are captured, such as a uniquely patterned wing or antenna structures.

Misidentification (True negative) and Not-Found cases (False Negative) commonly occur when the insect is too small in the image, the viewing angle obscures key features, only a portion of the insect is visible, or multiple insects are present, which could confuse the model. The percentage of misidentification may be particularly high for certain species that are visually difficult to distinguish. For example, those that closely resemble other species or require internal morphological features for accurate identification.

A relatively smaller portion of images are classified as Found with a specific species identified despite lacking sufficient visible insect characteristics (False positive), such as blank image identified with a present species. This behavior is expected and may be due to the iNaturalist model being trained on user-submitted observations. Such training data may contain mislabeled or noisy images, leading the model to learn spurious correlations that occasionally result in confident but incorrect identifications.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. An insect trap system comprising:
an insect trap device; and
a computing device coupled to the insect trap device, the computing device comprising a memory having instructions stored thereon for selectively trapping an insect in the insect trap device and one or more processors coupled to the memory and configured to execute stored instructions to:
determine an identity of an insect located within the insect trap device; and
operate the insect trap device to selectively trap, based on the determined identity, the insect within the insect trap device.

2. The insect trap system of claim 1, wherein the insect trap device comprises:
an identification chamber; and
an imaging device coupled to the computing device and configured to obtain an image of the insect when located in the identification chamber insect, wherein the one or more processors are further configured to:
receive the image of the insect from the imaging device; and
determine the identity of the insect based on the received image.

3. The insect trap system of claim 2, wherein the insect trap device further comprises:
an entrance device configured to direct the insect into the identification chamber.

4. The insect trap system of claim 3, wherein the entrance device is funnel shaped.

5. The insect trap system of claim 3, wherein the entrance device further comprises an attractor selected from the group consisting of a light, an LED light, scents, chemical attractants, and pheromones.

6. The insect trap system of claim 2, wherein the one or more processors are further configured to:
analyze the received image of the insect using a trained artificial intelligence model; and
determine the identity of the insect based on the analysis of the received image.

7. The insect trap system of claim 6, wherein the trained artificial intelligence algorithm utilizes a database of relevant insect images.

8. The insect trap system of claim 2, wherein the one or more processors are further configured to:
determine whether the insect is harmful based on the determined identity of the insect.

9. The insect trap system of claim 8, wherein the one or more processors are configured to determine whether the insect is harmful based on a trained artificial intelligence model.

10. The insect trap system of claim 8, wherein the insect trap device further comprises:
an elimination chamber and a release chamber coupled to the identification chamber; and
a transfer device configured to selectively transfer the insect from the identification chamber to the elimination chamber or release chamber, wherein the one or more processors are further configured to:
operate the transfer device to selectively transfer the insect from the identification chamber to the elimination chamber or the release chamber based on the determination of whether the insect is harmful.

11. The insect trap system of claim 10, wherein the elimination chamber is configured to kill the insect.

12. The insect trap system of claim 11, wherein the elimination chamber comprises an insect crusher configured to crush the insect when located in the elimination chamber.

13. The insect trap system of claim 10, wherein the release chamber is configured to release the insect from the insect trap device.

14. A method of selectively trapping an insect in an insect trap device implemented by an insect trap system, the method comprising:
determining, an identity of an insect located within the insect trap device; and
operating the insect trap device to selectively trap, based on the determined identity, the insect within the insect trap device.

15. The method of claim 14 further comprising:
receiving an image of the insect from an imaging device associated with the insect trap device; and
determining the identity of the insect based on the received image.

16. The method of claim 15 further comprising:
analyzing the received image of the insect using a trained artificial intelligence model; and
determining the identity of the insect based on the analysis of the received image.

17. The method of claim 16, wherein the trained artificial intelligence algorithm utilizes a database of relevant insect images.

18. The method of claim 15 further comprising:
determining whether the insect is harmful based on the determined identity of the insect.

19. The method of claim 18, wherein the determination of whether the insect is harmful is based on a trained artificial intelligence model.

20. The method of claim 18 further comprising:
selectively transferring the insect to an elimination chamber configured to kill the insect within the insect trap device when the insect is determined to be harmful; and
selectively transferring the insect to a release chamber configured to release the insect from the insect trap device when the insect is determined to be non-harmful.
